(19) United States
(12) Patent Application Publication
(10) Pub. No.: US 2017/0100992 A1
(43) Pub. Date: Apr. 13, 2017

(54) ADJUSTABLE SUN VISOR

(71) Applicant: Armenio Ruybal, Antonito, CO (US)

(72) Inventor: Armenio Ruybal, Antonito, CO (US)

(21) Appl. No.: 15/285,483

(22) Filed: Oct. 5, 2016

Related U.S. Application Data
(60) Provisional application No. 62/238,217, filed on Oct. 7, 2015.

(51) Int. Cl. B60J 3/02

(52) U.S. Cl. CPC B60J 3/0252

(57) ABSTRACT

An adjustable sun visor comprising a rotational mounting having an adjustable rod extending downwardly therefrom; a primary support rod perpendicularly connected end-to-end with the adjustable rod via an angular joint; a visor mounted to the primary support rod, the visor comprising a visor body including an upper longitudinal edge, a secondary support rod, and a and a primary support rod sleeve with an opening leading axially thereto; wherein the secondary support rod resides towards the end of the upper longitudinal edge of the visor opposite the opening of the primary support rod sleeve; wherein the primary support rod sleeve is aligned axially with the secondary support rod and the primary support rod traverses into the primary support rod sleeve through the opening wherein it is hidden in the interior of the visor.

### CROSS-REFERENCE TO RELATED APPLICATIONS

The present application claims priority to U.S. Provisional Patent Application Ser. No. 62/238,217, filed on Oct. 7, 2015, the disclosure of which is hereby incorporated in its entirety at least by reference.

### BACKGROUND OF THE INVENTION

Field of the Invention

The present invention relates generally to sun visors and, more particularly, to improved adjustable sun visors for vehicles.

Background of the Invention

The use of sun visors is known in the related art. Sun visors are customarily used in vehicles to shield the eyes of drivers and front seat passengers from the harsh brightness of incoming sunlight. Especially for the driver, the incidence of sunlight on the eyes inhibits vision. This poses a serious safety hazard on the driver and any other occupants of the vehicle, as reduced visibility severely impairs the driver's ability to safely navigate roads and avoid possible collisions. Harsh sunlight incident on the eyes has also been known to cause physical discomfort and permanent eye damage or blindness.

Sun visors of the related art are generally rotatable in two directions. The first rotation allows an operator, either the driver or front seat passenger, to swing the visor from the interior roof of the vehicle to the windshield and cover up an upper portion of the windshield. The second rotation allows an operator to swing the visor from the windshield to the adjacent side window and cover an upper portion of the adjacent side window. In effect, an operator can shield his or her eyes from head-on sunlight or lateral sunlight. However, current sun visors are restricted to these two rotational degrees of freedom. Sunlight is imposed at a more direct angle with a driver or front passenger's eyes when the sun descends below the bottom visor during sunset. Likewise, sunlight is also imposed at a more direct angle before the sun ascends above the bottom of the visor during sunrise. Current sun visors cannot generally be extended to low enough positions to shield the eyes of many drivers and passengers from low-level sunlight, which causes the previously discussed safety hazard, physical discomfort, and potential eye damage.

Therefore, it is an object of the present invention to provide and adjustable sun visor which is vertically extendable to low enough positions to shield a person's eyes during times of the day when light from the sun is more directly in the field of vision necessary to operate a vehicle. It is another object of the present invention to overcome the deficiencies of the related art related to safety, comfort, and vision preservation, by providing an adjustable sun visor which is vertically extendable. It is yet another object of the present invention to protect a driver and front passenger's face from ultra violet radiation and intense temperatures associated with the transfer of energy from sunlight to the skin.

### BRIEF SUMMARY OF THE INVENTION

In one embodiment of the present invention an adjustable sun visor is provided, comprising a rotational mounting having an adjustable rod extending downwardly therefrom; a primary support rod perpendicularly connected end-to-end with the adjustable rod via an angular joint; a visor mounted to the primary support rod, the visor comprising a visor body including an upper longitudinal edge, a secondary support rod, and a and a primary support rod sleeve with an opening leading axially thereto; wherein the secondary support rod resides towards the end of the upper longitudinal edge of the visor opposite the opening of the primary support rod sleeve; wherein the primary support rod sleeve is aligned axially with the secondary support rod and the primary support rod traverses into the primary support rod sleeve through the opening wherein it is hidden in the interior of the visor; and wherein the rotational mounting is affixed to an interior roof of a vehicle body or a windshield of a vehicle, and the adjustable rod extends downwardly from the rotational mounting.

In one embodiment, the visor is rotatable around the axis of the primary support rod, permitting to rotate between a not-in-use position and an in-use position, wherein in the not-in-use position, the visor lies approximately parallel with the interior roof of the vehicle body. In another embodiment, the angular joint is a separate component that telescopically receives the ends of the adjustable rod and the primary support rod. In one embodiment, the angular joint is a ninety-degree bend in the primary support rod that seamlessly adjoins it simply as a horizontal extension of a lower portion of the adjustable rod. In another embodiment, the rotational mounting receives the adjustable rod in axial alignment and, when the visor is rotated to the in-use position, permits horizontal rotation of the adjustable rod therein. In yet another embodiment, the adjustable rod is retractably extendable from an initial position such that a vertical height of the visor in relation to an eye of an vehicle operator may be adjusted, such that from its initial position, the adjustable rod may be extended downwardly up to two inches and reside at any distance between providing the operator with variable shade from the sun, especially at times of the day when the sun is closest to the horizon.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments. Referring to the drawings in which like reference character(s) present corresponding part(s) throughout:

FIG. 1 is an exemplary front elevation view of an adjustable sun visor according to an embodiment of the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

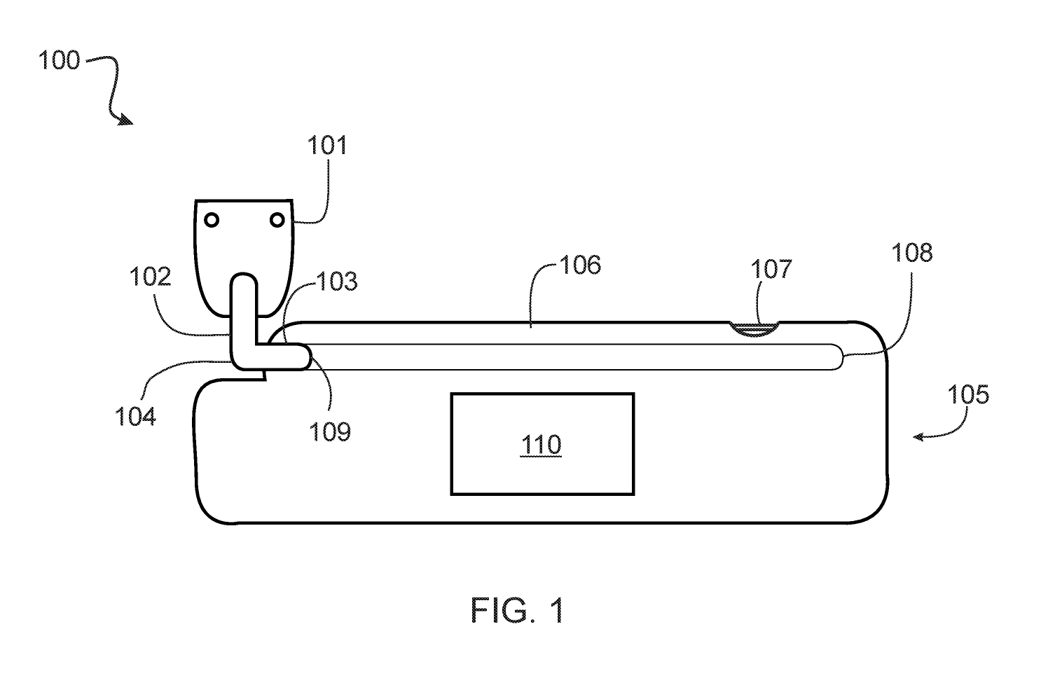

FIG. 1 is an exemplary front elevation view of an adjustable sun visor 100 according to an embodiment of the present invention. Referring now to FIG. 1, the adjustable sun visor may be employed in a vehicle as well known in the art. It should be appreciated by those having ordinary skill in the related art that the adjustable sun visor can be employed in any type of vehicle, such as, but not limited to, personal and commercial vehicles as well as construction vehicles. It should also be appreciated that the adjustable sun visor can be used on the driver side and the front passenger side of the vehicle, wherever it may be applicable. As shown in FIG. 1, the adjustable sun visor comprises a rotational mounting 101 having an adjustable rod 102 extending downwardly therefrom, a primary support rod 103 perpendicularly connected end-to-end with the adjustable rod via an angular joint 104, a visor 105 mounted to the primary support rod, and a visor clip (not pictured) fastened to the vehicle body to which the visor is detachably connected.

The visor further comprises a visor body 106, a secondary support rod 107, and a primary support rod sleeve 108 with an opening 109 leading axially thereto. The visor body blocks the rays of the low sun entering the vehicle through the windshield or adjacent side window, depending on where the operator desires to locate the adjustable sun visor. The visor body may be manufactured to be any desirable shape, but preferably has an overall shorter, lateral width of five to six inches and a longer, longitudinal length of fifteen to seventeen inches. The secondary support rod resides towards the end of the upper longitudinal edge of the visor opposite the opening of the primary support rod sleeve. The secondary support rod is a conventional sun visor element that detachably connects to the visor clip adapted to be fastened to the upper molding of the vehicle's windshield or roof frame. The primary support rod sleeve is aligned axially with the secondary support rod. It forms a hidden tunnel in the interior of the visor, travelling along the upper longitudinal edge and terminating at an opening located on the opposite end, which receives the primary support rod.

The primary support rod traverses into the primary support rod sleeve through the opening wherein it is hidden in the interior of the visor. It supports the visor in a cantilever-like fashion, connecting it to the rest of the adjustable sun visor. The visor is rotatable around the axis of the primary support rod, permitting to rotate between a not-in-use position and an in-use position. In the not-in-use position, the visor lies approximately parallel with the interior roof of the vehicle body. It is also in this position that the visor is temporarily affixed to the interior roof via the detachable connection of the secondary support rod to the visor clip. When an operator desires to move the visor into the in-use position, he or she disengages this connection and rotates the visor about the primary support rod so that it lies approximately parallel to the windshield, thereby blocking incoming rays of the low sun.

As previously described, the primary support rod is perpendicularly connected end-to-end with the adjustable rod via an angular joint. The angular joint may be a separate component that telescopically receives the ends of the adjustable rod and the primary support rod. The angular joint may also be a ninety-degree bend in the primary support rod that seamlessly adjoins it simply as a horizontal extension of the lower portion of the adjustable rod. This arrangement rigidly connects the visor to the adjustable rod. The adjustable rod extends downwardly from the rotational mounting. The rotational mounting is normally affixed to the upper molding of the vehicle's windshield or roof frame. The rotational mounting receives the adjustable rod in axial alignment and, when the visor is rotated to the in-use position, permits horizontal rotation of the adjustable rod therein. This rotational action thereby permits the adjustable sun visor to be swung from the windshield to the adjacent side window of the car, wherein the visor lies approximately parallel to the adjacent side window. Furthermore, the adjustable rod is retractably extendable from an initial position such that the vertical height of the visor in relation to eye of the vehicle operator or front passenger can be adjusted. From its initial position, the adjustable rod may be extended downwardly up to two inches and reside at any distance between. In effect, the visor provides the operator with variable shade from the sun, especially at times of the day when the sun is closest to the horizon. With the added capability of vertical adjustment, the adjustable sun visor is able to shield an operator's eyes from incoming sun light more effectively and during longer portions of the day than conventional sun visors. The physical discomfort and safety hazard posed by low-level sun light inhibiting a driver or passenger's vision as the sun rises or sets is diminished.

The adjustable sun visor may include a releasable locking mechanism disposed within the rotational mounting such that when the visor is rotated to the adjacent side window, the rotatability of the adjustable rod is temporarily restricted. This temporary restriction of rotation holds the visor in place over the side window so that it does not accidentally rotate away from the window without the strict intention of and application of force by operator for it to do so. The operator may still easily remove the adjustable sun visor from the side window by swinging it back to the windshield. The releasable locking mechanism may also be configured such that it additionally restricts the vertical adjustability of the adjustable rod to only when the visor is rotated to the side window. The visor may not be vertically adjustable when it is positioned over the windshield.

In one embodiment of the present invention, the adjustable rod is a hydraulic cylinder or pneumatic cylinder (not shown) which uses the power of compressed fluid to actuate the linear, reciprocating motion of the adjustable rod and achieve the desired two-inch range of downward extendibility. In such an embodiment, the adjustable rod is automatically actuated through electromechanical means. A control system is contemplated such that the operator need only activate an electrical switch to control the, actuation of the hydraulic or pneumatic cylinder, and thereby control the up and down motion of the adjustable sun visor.

In another embodiment of the present invention, the adjustable rod is configured as manually operated telescoping tubes (not shown). A smaller diameter inner tube is mounted telescopically in a larger diameter out tube and is slidably movable therein. The inner tube is slideable to achieve the desired two-inch range of downward extendibility of the adjustable rod. In another embodiment of the present invention, the visor body comprises a mirror 110.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention. For instance, although a skullcap having four equal triangle curve portions are disclosed, any number of triangle curve portions may be included such as six triangle curve portions or more.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. An adjustable sun visor comprising:
a rotational mounting having an adjustable rod extending downwardly therefrom;
a primary support rod perpendicularly connected end-to-end with the adjustable rod via an angular joint;
a visor mounted to the primary support rod, the visor comprising a visor body including an upper longitudinal edge, a secondary support rod, and a and a primary support rod sleeve with an opening leading axially thereto; wherein the secondary support rod resides towards the end of the upper longitudinal edge of the visor opposite the opening of the primary support rod sleeve; wherein the primary support rod sleeve is aligned axially with the secondary support rod and the primary support rod traverses into the primary support rod sleeve through the opening wherein it is hidden in the interior of the visor; and
wherein the rotational mounting is affixed to an interior roof of a vehicle body or a windshield of a vehicle, and the adjustable rod extends downwardly from the rotational mounting.

2. The adjustable sun visor of claim 1, wherein the visor is rotatable around the axis of the primary support rod, permitting to rotate between a not-in-use position and an in-use position, wherein in the not-in-use position, the visor lies approximately parallel with the interior roof of the vehicle body.

3. The adjustable sun visor of claim 1, wherein the angular joint is a separate component that telescopically receives the ends of the adjustable rod and the primary support rod.

4. The adjustable sun visor of claim 1, wherein the angular joint is a ninety-degree bend in the primary support rod that seamlessly adjoins it simply as a horizontal extension of a lower portion of the adjustable rod.

5. The adjustable sun visor of claim 1, wherein the rotational mounting receives the adjustable rod in axial alignment and, when the visor is rotated to the in-use position, permits horizontal rotation of the adjustable rod therein.

6. The adjustable sun visor of claim 5, wherein the adjustable rod is retractably extendable from an initial position such that a vertical height of the visor in relation to an eye of an vehicle operator may be adjusted, such that from its initial position, the adjustable rod may be extended downwardly up to two inches and reside at any distance between providing the operator with variable shade from the sun, especially at times of the day when the sun is closest to the horizon.
